(19) United States
(12) Patent Application Publication
(10) Pub. No.: US 2015/0106174 A1
(43) Pub. Date: Apr. 16, 2015

(54) COMPUTERIZED SYSTEM AND METHOD FOR DISCOUNTING AND PROMOTING AUTOMOBILES FOR SALE

(71) Applicant: Car Price Countdown, LLC, Delaware, OH (US)

(72) Inventor: Ryan Gill, Delaware, OH (US)

(21) Appl. No.: 14/513,998

(22) Filed: Oct. 14, 2014

Related U.S. Application Data
(60) Provisional application No. 61/890,692, filed on Oct. 14, 2013.

(51) Int. Cl. G06Q 30/02

(52) U.S. Cl. CPC G06Q 30/0283; G06Q 30/0207
USPC 705/14.1

(57) ABSTRACT

The present invention is a system and method for calculating a series of discounted sale prices for one or more vehicles offered for sale and making those calculated sale prices available to one or more potential vehicle purchasers such that the discounted sale prices each correspond to a series of elapsed time periods and are withheld from the potential vehicle purchasers until the period of time corresponding to a discounted sale price occurs.

### TECHNICAL FIELD

Exemplary embodiments relate to systems and methods for discounting the price of automobiles and offering the discounted automobiles for sale. A preferred exemplary embodiment applies a discount rate to an automobile that is being offered for sale such that the price of the automobile is decreased in increments over a period of time, from a starting price until the automobile is sold or until a predetermined lowest price is hit. The system preferably generates a website for display by a remote computer wherein the website advertises a plurality of vehicles being offered for sale all of which have a sale price which is being discounted in increments over a period of time.

### BACKGROUND AND SUMMARY OF THE INVENTION

Cars have historically been sold via brick and mortar dealerships which each maintain an inventory of vehicles and a team of salesmen on hand to interact with potential customers and to facilitate vehicle sales. This method lends itself well to the sale of vehicles which are typically a costly purchase and which potential buyers often like to test drive. Dealerships make a profit through negotiating a sales price for the vehicle as well as by adding on to the sale of the vehicle through extended warranties, additional vehicle features, etc., and through financing. Though one tends to think of new cars when thinking of a car dealership, the sale of used cars is also a profitable business for dealerships. This is because used vehicles are each a one of a kind item and unlike with new cars, only the dealership typically knows what it has invested in the used vehicles it offers for sale. Accordingly, the dealership often has a negotiating advantage in selling used cars that lends itself to profitability. This traditional sales method has encouraged a lack of transparency in used vehicle sales. And though car dealerships have developed internet websites, they have struggled to make the websites a frequently visited destination by potential customers.

Exemplary embodiments of the present system and method bring more transparency to the business of vehicle sales while encouraging repeat visits to the dealership's website. In one exemplary embodiment, car inventory data is entered into the system and stored in at least one database. The car inventory data may comprise vehicle identifying data for at least one vehicle where the data may comprise make, model, year, and/or mileage information. The car inventory data preferably also comprises a sales price for the at least one car. The car inventory data may be obtained by the system in a variety of ways. In a preferred exemplary embodiment, the system obtains a dealership specific data file periodically wherein the data file contains car inventory data for the dealership. Such a file may be obtained nightly by the system permitting the system to obtain car inventory data for all vehicles which have been purchased by the dealership in the preceding 24 hour period. V-AUTO®, (vAuto Inc. Oakbrook Terrace, Ill.) is an exemplary source of such a data file although it is not the only source. In some exemplary embodiments, at least some of the car inventory data may be entered into the system manually by a system user accessing an interface of the system via a remote computer.

The cars for which inventory data is obtained by the system are preferably used cars, but may be new cars or a mixture of new and used cars in some embodiments. In a preferred exemplary embodiment, the system obtains a discount rate which is to be utilized in discounting the sales price of at least one inventoried car. The system then (or alternatively at a later time) begins applying the discount rate to the sales price of the vehicle. In a preferred embodiment, the discount rate is applied to the sales price of the vehicle by the periodic running of software instructions which generate a table of data wherein the data includes at least two upcoming periods of time and a corresponding sale price of the car for each time period. The table may be stored by the server and utilized, for example upon receiving a request from a remote computer to see details pertaining to at least one vehicle, to send the discounted sales price of the vehicle for display by the remote computer. Preferably, a current, discounted price of the vehicle is displayed on the remote computer via the website of the automobile dealer that maintains the vehicle in its inventory. In a preferred exemplary embodiment, the system sends for display by a remote computer the starting sales price for the car and the current, discounted sales price for the car but does not send the discount rate for display nor does it send the amount of time over which the vehicle's price has been discounted. In such an exemplary embodiment, customers are inclined to spend additional time on the website in order to watch/monitor the vehicle's price discounted over time so that they can determine the discount rate that is being applied to the vehicle.

In some embodiments, the system may obtain car inventory data via manual entry by a system user. The system may analyze obtained inventory data (whether or not it has been obtained via manual entry by a system user) and determine a starting sales price for at least one inventoried vehicle and may additionally suggest a discount rate to be applied to said vehicle over a given period of time. The system may prompt a system user to accept or decline the suggested starting sales price and/or the proposed discount rate and may give the system user the option of overriding the proposed starting sales price and/or the discount rate by entering other values. Once the sales price and discount rate have been provided to the system by accepting the values that the system generated or by overriding those values, the system may send the sales price of the vehicle for display by a remote computer and may additionally begin discounting the sales price of the vehicle in accordance with the discount rate. The system may permit for the system user to set a time in the future when the system is to begin applying the discount rate to the starting sales price of the vehicle.

### BRIEF DESCRIPTION OF THE DRAWINGS

Novel features and advantages of the present invention, in addition to those mentioned above, will become apparent to those skilled in the art from a reading of the following detailed description in conjunction with the accompanying drawings wherein identical characters refer to identical parts and in which:

FIG. 1 is a schematic of an exemplary system for discounting and offering automobiles for sale;

FIG. 2 is a screenshot of an exemplary inventory summary web page which may be generated by the system for display by a remote computer of the dealership which maintains the inventory;

FIG. 3 is a screen shot of an exemplary vehicle inventory data web page which may be generated by the system for display by a remote computer of the dealership which maintains the inventory;

FIG. 4 is a screen shot of a vehicle summary web page which may be generated by the system and sent for display by a remote computer upon receiving a request from the remote computer to view the information for said vehicle;

FIG. 5 is a flow chart of an exemplary data gathering conversation which may be conducted by the system upon receiving a request from a remote computer to send a notification when the price for a vehicle reaches a certain value;

FIG. 6 is an exemplary table of data which may be generated by the system and stored in the at least one data base so that the system may send for display by a remote computer a current, discounted sales price for at least one automobile;

FIG. 7 is a second exemplary table of data which may be generated by the system and stored in the at least one data base 24 hours after the exemplary table of FIG. 6 has been generated;

FIG. 8 is an exemplary embodiment of a window sticker comprising an LED screen that may be utilized in some embodiments of a system and method for discounting and promoting automobiles for sale; and

FIG. 9 is a screen shot of an exemplary search results web page which may be generated by the system and sent for display by a remote computer upon receiving search parameters from the computer.

### DETAILED DESCRIPTION OF EXEMPLARY EMBODIMENT(S)

As used herein, the terms “car”, “automobile” and “vehicle” are used to describe vehicles offered for sale. One skilled in the art will understand that the invention described need not be limited to just these type and may be applied equally to other types of vehicles including, but not limited to, trucks, motorcycles, watercraft, and aircraft, where such vehicles may commonly be sold.

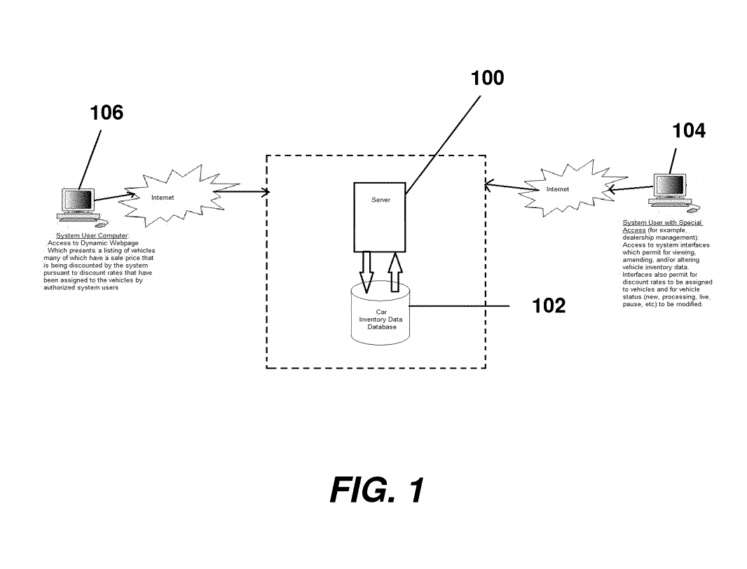

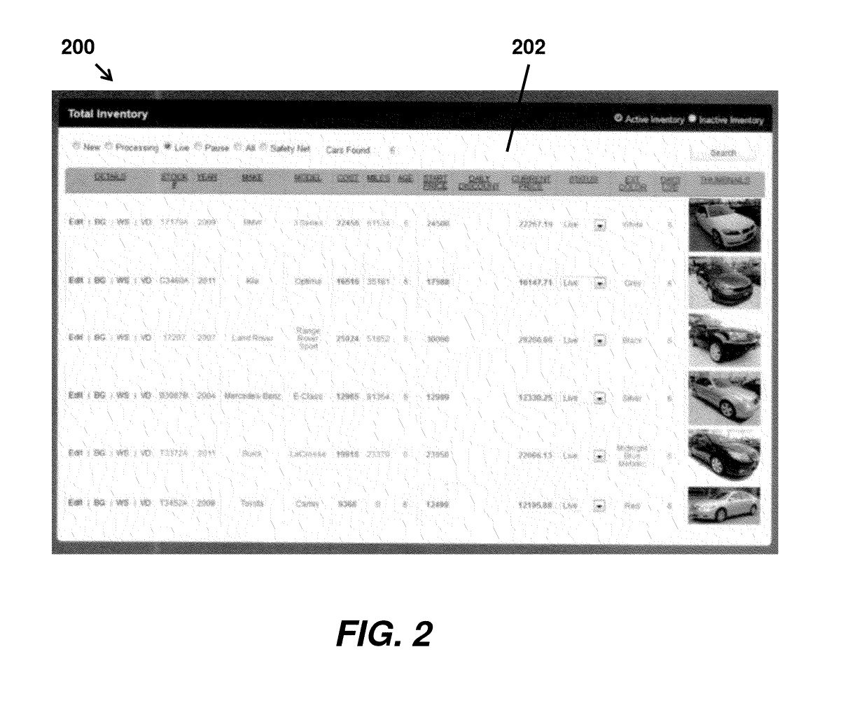

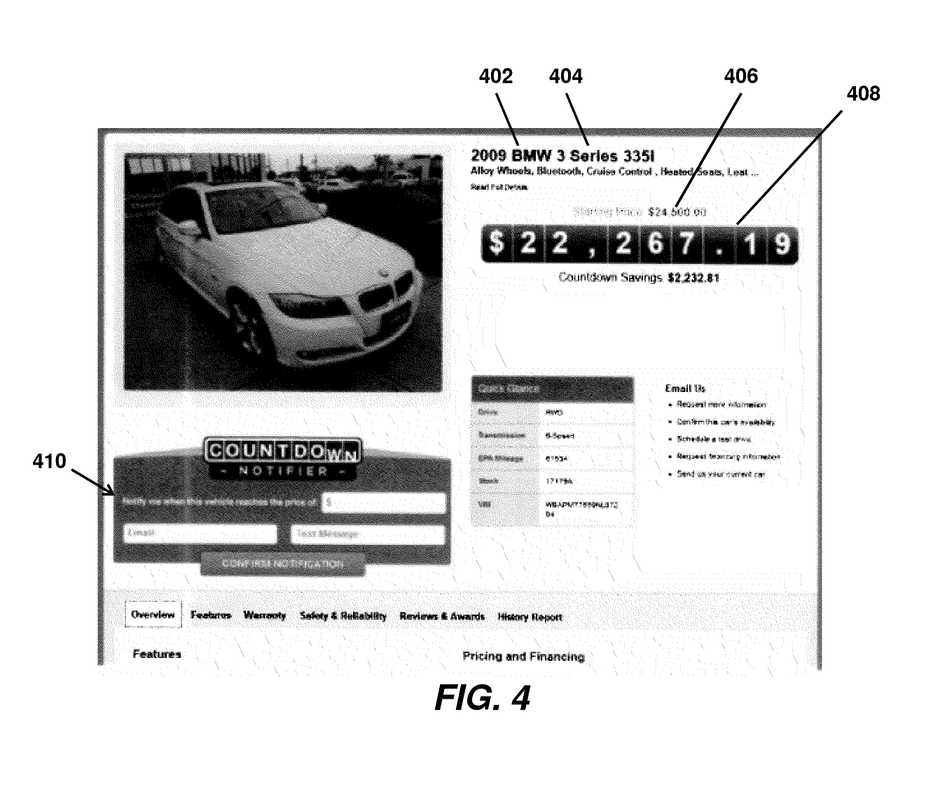

A system and method for discounting vehicles as shown in FIG. 1 may comprise at least one server 100 in electrical communication with at least one database 102. In a preferred exemplary embodiment, the at least one server accesses vehicle inventory data for at least one inventoried automobile being offered for sale (or that will be offered for sale in the future) by a car dealership, individual, business, etc., said data having been stored in the at least one database, and generates a web page or a set of web pages for display by a remote computer 104 wherein the web page or set of web pages displays on at least one web page at least part of the inventory data of at least one automobile and permits for at least some of the inventory data pertaining to the automobile to be modified by a qualified system user. The at least one automobile is preferably a used automobile but may be a new automobile or a combination of new and used vehicles in some embodiments. Preferably, multiple vehicles are inventoried and represented on the web page(s). FIG. 2 shows an exemplary web page 200 which may be generated by the system for display by a remote computer of a qualified system user 106. This web page may be generated by the system for a system administrator upon receiving adequate log-in credentials from a remote computer. As can be seen, the dynamic web page may send for display, for each inventoried vehicle, a current sale price as well as other information pertaining to the vehicle. The web page preferably permits for a qualified system user to access the vehicle inventory data and modify at least some of the data. In the exemplary embodiment shown in FIG. 1, the system also generates and sends for display by a remote computer a web page which displays the inventory data of at least one automobile, including a current sale price for the at least one vehicle, but which does not permit for any modifications to be made to the inventory data corresponding to the at least one inventoried vehicle. Preferably, no log-in credentials are required to access this web page and thus the page can be accessed by anyone with internet access. FIG. 4 shows an exemplary embodiment of a web page which may be generated by the at least one server for display by a remote computer 106 by accessing vehicle inventory data stored in the at least one database 102 wherein the page displays an inventory of vehicles being offered for sale and which displays, for each inventoried vehicle, a current sales price.

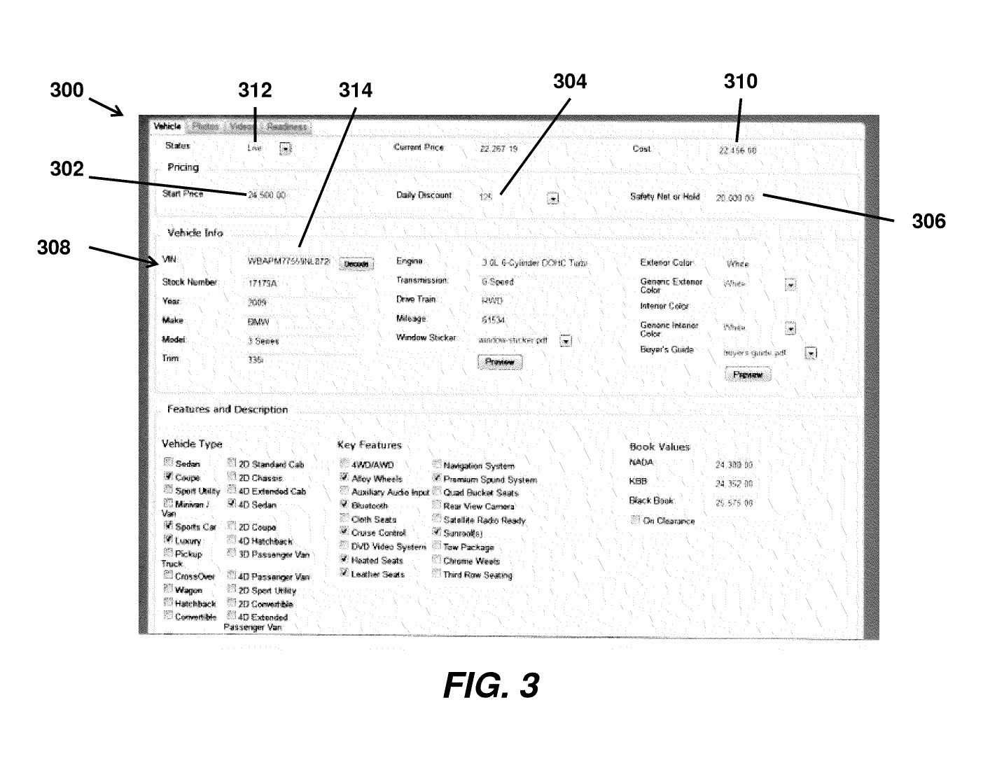

Preferably, the sale price of the at least one inventoried automobile is discounted by the system at regular intervals of time (“discount intervals”) until the vehicle is sold or until the sale price of the vehicle reaches a predetermined minimum sale price. For example, the price of the vehicle may be discounted $20 each half hour (wherein 30 minutes would be the discount interval), $130 an hour (wherein an hour would be the discount interval), etc. The amount of the discount being regularly made to the price of the vehicle is the discount rate. The discount rate is preferably supplied to the system via manual entry by a system user who sends the rate to the system via a remote computer. FIG. 3 shows a screenshot of an exemplary vehicle inventory data summary page 300 which may be generated by the system and sent for display by a remote computer upon receiving adequate log-in credentials. This is preferably generated by the system as part of a set of web pages which may be accessed only by qualified system users. In preferred exemplary embodiments, such a page may only be accessed by administrator(s) employed or contracted by a dealership which maintains the inventoried vehicle because it permits for interactions with the system which can alter the vehicle's inventory data that is stored in the database. As can be seen, the system may generate a variety of data entry fields pertaining to an inventoried vehicle for display by the remote computer. Such data entry fields may comprise a Start Price data field 302, a Daily Discount data field 304, a Safety Net data field 306, and a variety of Vehicle Information data fields 308. Preferably, the data within the Vehicle Information data entry fields is supplied by the system so that it does not have to be entered manually by a system user. The data pertaining to the Start Price, Daily Discount, and Safety Net data fields is preferably supplied to the system via manual entry from a remote computer accessing the dynamic web page. In this exemplary embodiment entering a numerical value into the Daily Discount data entry field is the manner in which the discount rate is supplied to the system. FIG. 3 shows a discount rate 304 of $125 a day being supplied to the system so that the inventoried vehicle (in this example a 2009 BMW) may have its sale price discounted by $125 a day. In a preferred exemplary embodiment where the price of at least one vehicle is being regularly discounted, the website makes the discounted price of the at least one vehicle available for viewing. In some exemplary embodiments, the price of the vehicle displayed by the website is current as of the time the at least one server receives a request from a remote computer to see details pertaining to the inventory or vehicles, a specific vehicle, etc.

In order to generate a dynamic web page and discount the sale price of at least one automobile, the at least one database of the system may comprise vehicle inventory data such as make, model, year, and mileage information for the at least one vehicle that has been inventoried by a car dealership, individual, etc. The web page shown in FIG. 3 provides an example of inventory data which may be obtained by the system. As shown in FIG. 3, the vehicle inventory data stored by the database may additionally comprise the cost 310 of the at least one vehicle to the dealership. The cost of the at least one vehicle to the dealership may include the cost the dealership paid to acquire the vehicle plus any money that has been invested into the vehicle by the dealership in getting it ready for sale. In preferred exemplary embodiments, at least some of the vehicle inventory data is entered into the database by a system user accessing an interface, for example as shown in FIG. 3, that has been generated by the at least one server and sent for display by a remote computer. The interface preferably provides data entry fields which enable data entered at the interface to be sent to the at least one system server and then to the at least one database. In some exemplary embodiments, at least some of the vehicle inventory data is not manually entered into the system via an interface. In such an example, the system may periodically (for example nightly) obtain vehicle inventory data by obtaining a data file which includes vehicle inventory data for vehicles which have been newly acquired by the dealership. Such a data file may be obtained from any dealership inventory management system (for example such as V-AUTO®). The system may then pull and/or copy the vehicle inventory data from the data file and store it in the at least one database. Once vehicle inventory data for a vehicle which has been newly added to the dealership's inventory has been obtained by the system and stored in the database, a qualified system user may be able to view information pertaining to the vehicle by accessing a total inventory web page for the dealership (like the one shown in FIG. 2). From there, a qualified system user may then review the vehicle inventory data, edit the vehicle inventory data, add vehicle inventory data (such as Start Price, Discount Rate, Safety Net), etc. This may be done through a vehicle inventory data summary page as shown in FIG. 3.

Once a qualified system user has reviewed vehicle inventory data for an automobile that has been newly acquired by a dealership, business, etc. and has selected a discount rate for the vehicle (by for example entering a discount rate of an amount of dollars per day to be discounted off the price of the vehicle in a data entry field of an interface as shown in FIG. 3), the system user may be able to offer the vehicle for sale through a web page that is generated by the system and which may be accessed by anyone with internet access. In the exemplary interface of FIG. 3, this is done by selecting the appropriate status for the vehicle 312B. Selecting a “live” status for the vehicle will cause the system to display the vehicle and at least some of its corresponding vehicle inventory data on a web page which may be generally accessed by anyone. This enables potential buyers of the automobile to view the vehicle and its current sale price.

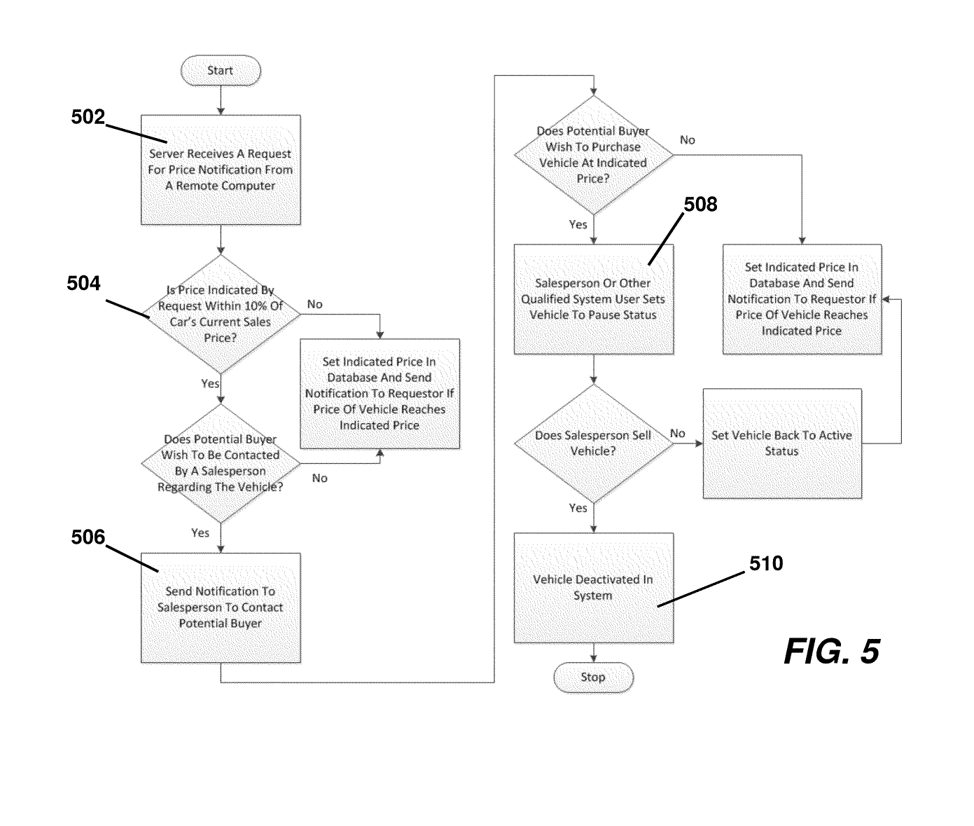

FIG. 4 shows an exemplary web page that may be generated by the system which displays details pertaining to a vehicle being offered for sale after being taken “live” by a qualified system user. The web page of FIG. 4 is preferably viewable by anyone with internet access. As can be seen, the web page preferably displays vehicle inventory data including make 402, model 404, starting sale price 406, and a current discounted sale price for the vehicle 408. As is illustrated by the flowchart of FIG. 5, in an exemplary embodiment of the invention, the system may also send for display at the web page, data entry fields which permit for potential buyers of the at least one automobile to receive a notification from the system when the sale price of the inventoried vehicle reaches a price which the individual potential buyer finds acceptable (“notification price”) 502. In preferred exemplary embodiments, upon obtaining a request for a notification from the remote computer of a potential buyer the system will analyze the notification price obtained in order to initiate a next step. For example, the system may determine that the notification price is within a certain pre-determined percentage from the current sale price of the vehicle 504 and may then cause a message to be sent to a salesman so that the salesman may contact the potential buyer 506. If the buyer expresses interest in purchasing the vehicle, the salesman or other qualified system user may set the vehicle to a paused status 508 while the salesperson and the potential buyer come to an agreement regarding the purchase of the vehicle. In the event that the purchase of the vehicle takes place, the vehicle may be deactivated in the system 510. In another exemplary embodiment, the system may generate a prompt for additional data entry to be displayed by the remote computer of a potential buyer. This may ask the potential buyer if he or she would like to speak to a salesman about the vehicle of interest, etc. In a preferred exemplary embodiment, the system may determine that the notification price would be an acceptable sale price for the vehicle (by for example using the safety net value which was supplied to the system by a qualified system user) and will accordingly offer the potential buyer a personal benefit (for example an additional discount off the vehicle) if he or she comes in to test drive the vehicle during a given time period.

In a preferred exemplary embodiment, inventory data stored in the at least one database comprises a starting sales price for each inventoried vehicle. The sales prices may have been obtained by the system upon their entry by a qualified system user accessing an interface such as that shown in FIG. 3. In other exemplary embodiments, the system may be able to analyze other inventory data pertaining to the vehicle in order to suggest a starting sales price for the vehicle. For example, the at least one server may obtain make, model, mileage, and condition information for an inventoried vehicle and analyze said data and suggest a starting sales price. The server may obtain said data from the database or alternatively may obtain said data from a remote computer said data having been provided by a system user. Once a starting sales price is generated by the at least one server, the system user may be given the opportunity to accept the starting sales price or to override the suggested price by entering a higher or lower starting sales price. The selected starting sales price may be sent to the at least one server which may send it to the database to be stored in conjunction with inventory data for a particular vehicle.

In order to facilitate the discounting of the inventoried vehicles, the at least one database 102 may comprise at least one discount rate. The discount rate may have been obtained by the system upon its being sent to the at least one server via an interface displayed by a remote computer (a system user having entered said discount rate at said interface and sent it to the server—again, an example of such an interface is shown in FIG. 3). Alternatively, the at least one server may analyze inventory data for at least one vehicle, said data having been retrieved from the at least one database, and suggest/adopt a discount rate depending on the data analyzed. In some embodiments, the server may comprise software instructions which are preconfigured with a specific discount rate which will be applied to the sale price of at least one inventoried vehicle when software instructions are executed by the at least one server. In one exemplary embodiment, the server comprises software instructions which, when run, accesses the starting sale price for at least one inventoried vehicle and generates a plurality of future sale prices for the vehicle using a discount rate. Accordingly, the plurality of future sale prices for the vehicle will be discounted from the starting sale price. Preferably, the plurality of future sale prices are stored by the system within a table which, as discussed in more detail below, may be utilized by the at least one server in generating the dynamic web page which comprises current sale price information for at least one inventoried vehicle. The software instructions of the at least one server may become configured with a discount rate for an inventoried vehicle when the system obtains a discount rate for the vehicle via an interface such as the exemplary web page interface shown in FIG. 3.

A discount rate utilized by the present system and method may take a variety of forms such as an amount of money to be discounted from the sales price of the vehicle over a given period of time, a percentage by which to discount the sales price of the vehicle over a given period of time, etc. A system user may be able to specifically instruct the system to apply at least one discount rate to at least one of the inventoried vehicles. For example, a system user may instruct the system to decrease the sales price of an inventoried vehicle by $100 per day. In one such exemplary embodiment, the at least one server generates an interface, such as that shown in FIG. 3, for display by a remote computer, said interface permitting a system user to select at least one inventoried vehicle and to indicate to the system the discount rate which is to be applied to said selected vehicle(s). The interface may additionally enable the system user to indicate to the system when it is to begin applying the selected discount rate. In the exemplary embodiment of FIG. 3, the system is instructed to begin applying the discount rate (as shown in the Daily Discount data entry field) 304 when a system user utilizes a pointing tool (such as a mouse) at a remote computer to select the Status data entry field of the interface and place the vehicle in “Live” status 312. The server may send for display at said interface inventory data pertaining to the selected vehicle(s) as well as at least one discount rate which may be selected by the system user in order to enable these selections by the system user. When more than one vehicle is selected, the system may permit the system user to apply a single discount rate to each of the selected vehicles or alternatively may permit the system user to apply a first discount rate to at least one selected vehicle, a second discount rate to at least one selected vehicle, and so on. In the exemplary embodiment of FIG. 3, the vehicle inventory data interface displays vehicle inventory data for a single inventoried vehicle at a time. But in some embodiments a vehicle inventory data interface could permit modifications to the vehicle inventory data of more than one vehicle at a time.

In some embodiments, the server may generate an interface comprising at least one data entry field which permits for the system user to manually enter a discount rate for at least one selected automobile and cause the discount rate to be sent to the at least one server 100. Once one or more discount rates have been obtained by the at least one server and associated with at least one selected vehicle, the system may begin applying the discount rate(s) to the sales price of the selected vehicle(s). The at least one server 100 may obtain a discount rate by obtaining software instructions which, when executed, discounts the sale price of at least one inventoried vehicle.

In one exemplary embodiment, the system applies the same discount rate to each vehicle for which inventory data has been entered into the at least one database 102. In such an exemplary embodiment, the at least one server may generate an interface for display by a remote computer which permits for the entry of inventory data pertaining to a vehicle and enables sending the data to the server and then to be stored in the at least one database. The server may send a request to the remote computer 104 via the interface to have a system user indicate a time at which the system is to begin applying the discount rate and may additionally send a request to the remote computer to be provided with a starting sales price for the vehicle as well as a minimum sales price for the vehicle (i.e. a “Safety Net” value) 306. The system may begin applying the discount rate to the vehicle in question at the time indicated by the system user and will continue to apply the discount rate to the sales price of the vehicle until the sales price reaches the minimum sales price. In another exemplary embodiment, the at least one server 100 obtains inventory data for a vehicle which has recently been added to the inventory. Upon receiving the inventory data, the system may begin applying a discount rate to the starting sale price of the vehicle. In a preferred embodiment, the system must receive an instruction before it begins applying the discount rate to the sales price of a vehicle. The system may be applying a discount rate (or different discount rates) to a plurality of inventoried vehicles at the same time, but may be at different stages of applying the discount rate depending on the vehicle at issue. For example, the system may have just begun applying the discount rate to at least one vehicle, be approximately half way through with applying the discount rate to another vehicle, and almost done with applying the discount rate to another vehicle.

In a preferred exemplary embodiment, the system applies one or more discount rates to an inventory of vehicles for which inventory data has been entered into the at least one database 102. In one such embodiment, the system has either obtained or determined a starting sales price and a minimum sales price for each of the vehicles. The starting sales price and minimum sales price likely varies from vehicle to vehicle especially if the inventory comprises used vehicles. When the starting sales prices and minimum sales prices vary from vehicle to vehicle, the length of time during which the system applies a discount rate to the sales price of the vehicle can vary even when the system is applying the same discount rate to each of the vehicles. In some exemplary embodiments, rather than obtain a minimum sales price for a vehicle to be offered for sale, the at least one server may receive an instruction, via a system user, regarding the length of time a discount rate is to be applied to a vehicle. Such a system may determine the minimum sales price of the vehicle by applying the discount rate for the specified period of time but is never actually provided with the minimum sales price. Even in such a system, the amount of time over which a discount rate (or multiple discount rates) is applied to a vehicle may vary between the vehicles being offered for sale.

In some exemplary embodiments, the server may apply more than one discount rate to the same vehicle. For example, the at least one server 100 may receive an instruction from a remote computer to apply a discount rate of $150 a day to a particular inventoried vehicle. After a few days, the at least one server may receive an instruction from a remote computer to apply a discount rate of $500 a day to the vehicle. When the instruction to apply the $500 a day discount rate to the vehicle is received, it may be an instruction to immediately begin applying the $500 a day discount to the vehicle or alternatively it may be an instruction to apply the $500 a day discount to the vehicle during a future time period which may also be provided to the at least one server 100 by a system user via a remote computer 104. These instructions are preferably sent to the at least one server 100 by a system user accessing an interface such as the exemplary interface shown in FIG. 3. A system user may be able to instruct the at least one server regarding how long it is to apply a first discount rate to the price of an automobile and how long it is to apply a second discount rate to the price of the automobile and may be able to send the instructions to the at least one server at the same time. So for example, a system user may be able to instruct the at least one server to apply a discount rate of $150 a day to the price of the vehicle for six days and then to apply a discount rate of $500 a day to the price of the vehicle for a single day. After the seventh day—on which the system has applied the $500 a day discount rate to the price of the vehicle—the system may return to applying the $150 a day discount to the price of the vehicle. In some embodiments, after the system has completed application of the second discount rate to the price of the vehicle, the vehicle may return to the sale price it had before the system began applying the second discount rate. In such an exemplary embodiment, the system may then begin applying the first discount rate to the price of the vehicle until it hits the Safety Net value 306 or alternatively until it is instructed to apply a third discount rate to the price of the vehicle for a period of time.

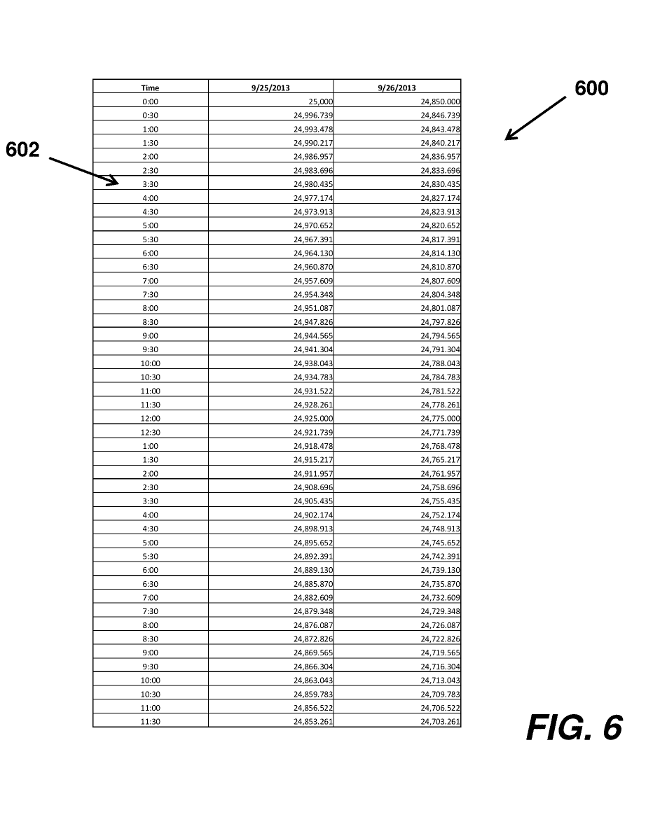

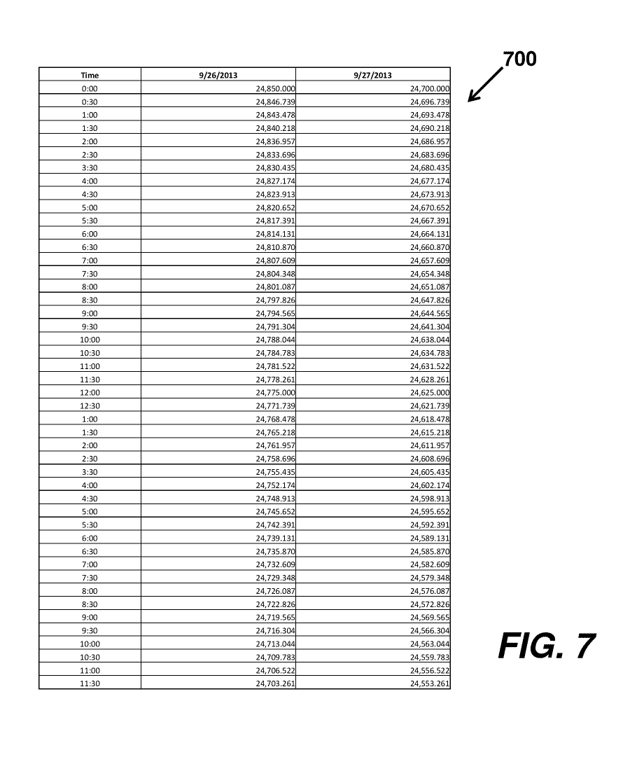

In a preferred exemplary embodiment, the at least one server 100 determines a plurality of sequential discounted price points (i.e. sale prices) for at least one inventoried vehicle in advance of the discount actually being applied to the vehicle(s) and generates a corresponding table of data. For example, the at least one server 100 may comprise software instructions which run every 24 hours (other periods of time may also be utilized) and which generates a table of data comprising a plurality of sequential price points where each price point is associated with a future time/period of time. An exemplary Pricing Schedule that may be generated by the at least one server 100 is shown in FIG. 6. As shown, the software instructions may generate a Pricing Schedule table 600 which includes discounted price points for at least one vehicle for each discount interval that will occur during the upcoming 48 hours. In the exemplary Pricing Schedule of FIG. 6, the discount rate is $150 per day, but the discount interval is every 30 minutes 602. Accordingly, the exemplary Pricing Schedule has 92 price points for the at least one vehicle which reflects the discounting of the vehicle that will occur over the 48 hours which follows the point in time in which the software instructions were run. When the software instructions run the next night, they may generate a table of data 700 as shown in FIG. 7. A preferred exemplary embodiment uses discount intervals of less than 30 minutes. For example, discount intervals of every 15 seconds. In such an exemplary embodiment, the system could create a table of data every night comprising 48 hours of discount data that would have 5,760 discounted price values for a vehicle (a price value for every 15 second discount interval over the 48 hour period).

Generated Pricing Schedules (or multiple schedules) as illustrated in FIGS. 6 and 7 may be stored by the at least one server 100 in the at least one database 102 and be utilized to provide the dynamic web page with a current sale price for each of the inventoried vehicles. For example, when the at least one server receives a request from a remote computer to see details pertaining to at least one inventoried vehicle, the server may access a generated Pricing Schedule, retrieve the sales price of the vehicle that is current and then generate a web page for display by the remote computer which displays the current sale price. The server may in some embodiments generate a HTML page having a dynamic data value for the current sale price embedded in the HTML code. In preferred exemplary embodiments, the at least one server has access to a clock/current time which is utilized to determine which price should be retrieved from the Pricing Schedule. So, in an example wherein the system has generated the Pricing Schedule shown in FIG. 6, a first customer might go to a website generated by the system at 10 PM on September 26th, search for an inventoried vehicle, and send a request to the at least one server 100 to see details pertaining to the vehicle. Upon receiving the request, the at least one server 100 may determine the current time to be 10 PM, access the Pricing Schedule, and retrieve the then current price of $24,713.04. The server may then generate and return a HTML page with the dynamic value of $24,713.04 pre-embedded in the HTML code. In the same example, if the same or different customer goes to the website at 10:35 PM on September 26^{th} and sends a request to the server (via a remote computer displaying the web page) to see details pertaining to the same vehicle, upon receiving the request, the at least one server may determine the current time to be 10:35 PM, access the Pricing Schedule and retrieve the then current price of $24,709.78. The server may then generate and return a HTML page with a dynamic value of $24,709.78 pre-embedded in the HTML code.

In some exemplary embodiments, the system generates a single Pricing Schedule which contains sequential price points (each of which corresponds to a future time and/or interval of time) for each vehicle that is part of the relevant inventory (or at least each inventoried vehicle which has been set to a live status). In such an example, the price points pertaining to each vehicle may be kept separate from those pertaining to other vehicles by storing them in conjunction with vehicle identifier information. In other exemplary embodiments, the system may generate a separate Pricing Schedule for each inventoried vehicle. In such an embodiment, the at least one server may receive a request from a remote computer to view details pertaining to an inventoried vehicle. The inventoried vehicle may be associated with a unique vehicle identifier. An example of such an identifier may be the vehicle identification number (VIN) illustrated at 314 of FIG. 3. This unique identifier may be assigned by the at least one server when the vehicle inventory data is initially entered into the system upon the vehicle becoming part of the relevant inventory, or alternatively the unique identifier may be data that is entered by a system user. The unique identifiers may be utilized by the system to store and retrieve Pricing Schedules for the proper vehicle. So for example, when the at least one server receives the request to view details pertaining to the inventoried vehicle, the request may include the vehicle's unique identifying data. The server may then access the Pricing Schedule which corresponds to the unique identifying data and retrieve the correct, current price for the vehicle from the Pricing Schedule.

In exemplary embodiments wherein the at least one server executes software instructions which generate at least one Pricing Schedule, the software instructions may do so by accessing the current sale price of at least one vehicle which may or may not be the starting sale price of the vehicle. In another exemplary embodiment, the server may access a future sale price for at least one vehicle as provided in the current pricing Schedule and may utilize the future price point to generate a new Pricing Schedule that will not immediately become the current pricing schedule. For example, if software instructions are run every 24 hours at midnight to generate 48 hours worth of discount pricing for at least one vehicle, the software instructions may utilize the 12:30 AM sale price of the vehicle as provided by the current pricing schedule, to generate the next pricing schedule which would not become the current pricing schedule until 12:30 AM. In some exemplary embodiments where the pricing schedule contains more than one day's worth of discounted price values, the system utilizes the last price point of a vehicle as provided in the current pricing schedule to generate at least one additional day's worth of discounted prices and generate a new Pricing Schedule. Generation of a “new” Pricing Schedule may in some embodiments be amendment of the existing Pricing Schedule to include additional discount price values for at least one inventoried vehicle.

In some exemplary embodiments that comprise a server which executes software instructions periodically to generate at least one Pricing Schedule comprising a plurality of sequential, discounted sales prices for at least one inventoried vehicle, the system is configured to amend the at least one Pricing Schedule based on the occurrence of certain events. The amendment of the at least one Pricing Schedule may be accomplished by the at least one server utilizing separate routines which are linked to at least one of the events. For example, if the server comprises software instructions which are scheduled to be run every 24 hours at midnight to generate a 48 hour pricing schedule which comprises two days worth of future, discounted prices for each inventoried vehicle, the server may comprise a set of software instructions which are linked to amending the Pricing Schedule in response to receiving inventory data for a new vehicle that has been added to the inventory during the day. This set of software instructions may utilize a discount rate and the starting sale price for the new vehicle to generate a plurality of sequential, discounted prices for the vehicle and may retrieve the current Pricing Schedule from the database and add the new vehicle to the Pricing Schedule in conjunction with its future discounted price points. Similarly, if a system user notices that an incorrect price has been entered into the system for a vehicle, there may be a set of software instructions which permit the Pricing Schedule to be amended with the correct price. In such an embodiment, the server may receive a request from a remote computer to correct a current sale price of at least one vehicle by a specific amount. In response to receiving the request, the server may execute a routine which retrieves the current Pricing Schedule and alters at least one price point for the vehicle by the amount specified. In a preferred embodiment, the routine would correct at least the current price of the vehicle within the Pricing Schedule as well as all future price points for the vehicle by the amount specified. The amended Pricing Schedule could then be sent to the at least one database to replace the previous version of the Pricing Schedule so that any future web page generations would be made using the data within the amended Pricing Schedule.

In embodiments comprising software instructions that are run every 24 hours to generate a Pricing Schedule having at least 48 hours worth of discounted prices for the inventoried vehicle(s), numerous system benefits may be achieved. First, this can be utilized to prevent heavy burdens on the system during the day (when the web page will often receive the most visits from potential customers) because software instructions won't have to be run every discount interval to generate the reduced price points of the inventoried vehicles. Second, if for some reason the software instructions are not run, the system still has 24 hours within the prior Pricing Schedules which may be utilized to keep the sale prices of the inventoried vehicles that are displayed by the website current.

In some exemplary embodiments, it is not necessary for a system user to refresh the dynamic web page in order to obtain a current, discounted price of an inventoried vehicle for which information has been sent by the at least one server for display, via the web page, at the remote computer. In other words, a static web page may display a current price of at least one inventoried vehicle even though the system has discounted the price of the vehicle since the web page was generated by the at least one system server. This functionality may be enabled by the system's utilization of Java or a similar program.

In one exemplary embodiment, the dynamic web page generated by the at least one server presents a graphical illustration corresponding to an inventoried vehicle wherein the illustration shows the price of the vehicle as it has been discounted over time (i.e. from the starting sale price to the current price of the vehicle). The graphical illustration may show the discount rate being applied to the sale price of the vehicle in real time. In other words, while at the web page you may be able to watch the discount being applied to the sale price of the vehicle via movement of the graphical illustration within the dynamic web page. In another exemplary embodiment, the graphical illustration shows the discount as it has been applied to the vehicle over time such that the information is current through the time a request to view details pertaining to the at least one vehicle was received by the at least one server. The graphical illustration is preferably generated using data from at least one Pricing Schedule that has been generated by the system.

Some exemplary embodiments may comprise real-time discounting of inventoried vehicles. For example, once a discount rate has been selected for at least one inventoried vehicle, the system may apply the discount rate to the price of the vehicle in real-time until the price of the vehicle reaches a pre-determined minimum sales price (in some embodiments called the “safety net” value) or alternatively until the system has applied the discount rate for a specified period of time. Even when the discount rate is an amount by which the price of the vehicle is to be reduced per day, the system may apply the discount to the price of the vehicle over smaller increments of time such as minutes, seconds, etc. and send the discounted price for display via the dynamic web page. So again by way of example, where the discount rate to be applied to a vehicle is $100 a day, the system may discount the sale price of the vehicle by $00.13889 cents per minute. In systems in which at least one vehicle is discounted in real time, the server may periodically run software instructions which updates a Pricing Schedule that contains the pricing information for each inventoried vehicle. The server may then utilize the data within the Pricing Schedule to generate the dynamic web page as has been discussed.

In some embodiments, the system may utilize inventory data to determine a discount rate to be applied to an inventoried vehicle. For example, the system may analyze the make, model, year, mileage, etc. of the vehicle and suggest a rate by which the vehicle should be discounted over time. In some exemplary embodiments, the at least one server analyzes the amount which the dealership has invested in at least one vehicle to suggest a discount rate. In some embodiments, the server can compare the amounts of money which the dealership has invested in each inventoried vehicle with the current sale prices of those vehicles in order to suggest a discount rate for a new vehicle being added to the inventory. So for example, if the system determines that the dealership currently has an inventory in which it has invested a significant amount of money and for which the dealership has already substantially discounted the sale prices of those vehicles, the system would suggest a small discount rate for the new vehicle. The at least one server 100 might also analyze at least some of the inventory data for the new vehicle in making its suggestion. A newer used vehicle with low mileage for example would get a lower discount rate suggested than an older vehicle with high mileage. In some exemplary embodiments, the system may apply a first discount rate to a first inventoried vehicle and a second discount rate to a second inventoried vehicle. The first discount rate may be different from the second discount rate. As discussed these rates may be suggested by the system upon analyzing inventory data for the inventoried vehicles, but in other embodiments the discount rates may be provided to the system via a system user or via software instructions that are executed by the server.

In a preferred exemplary embodiment of the present system and method, though the dynamic website displays an inventory of at least one vehicle and a current sale price for the vehicle, the vehicle cannot be purchased directly through the website. In such an embodiment, purchasing a vehicle which is included in the inventory may require a visit to the dealership which maintains the inventory. Such an embodiment would enable the dealership to establish a relationship with potential buyers as well as conduct test drives, etc. In some exemplary embodiments, at least some personal contact with the dealership must be made to purchase an inventory vehicle. For example, a phone call to a salesman at the dealership to execute the sale transaction or a visit to the dealership. In some exemplary embodiments, the system may permit for inventoried vehicles to be purchased through the dynamic web page.

An exemplary embodiment of the present system and method permits system users to select at least one inventoried vehicle and monitor its decreasing price. When a vehicle has been selected by a system user for such monitoring, the server may receive an indication from the remote computer that a monitoring request has been made. The server preferably updates the database with this information each time a monitoring request for a vehicle is received. Preferably the system obtains computer identifying information with each request so it can distinguish new requests from repeat requests from the same computer. When the server receives a request from a remote computer to view details pertaining to an inventoried vehicle, the web page generated by the server and sent for viewing by the remote computer may include an indication of how many monitoring requests the server has received for the particular vehicle. This may permit system users to gauge how likely it is that the vehicle will be sold in the near future.

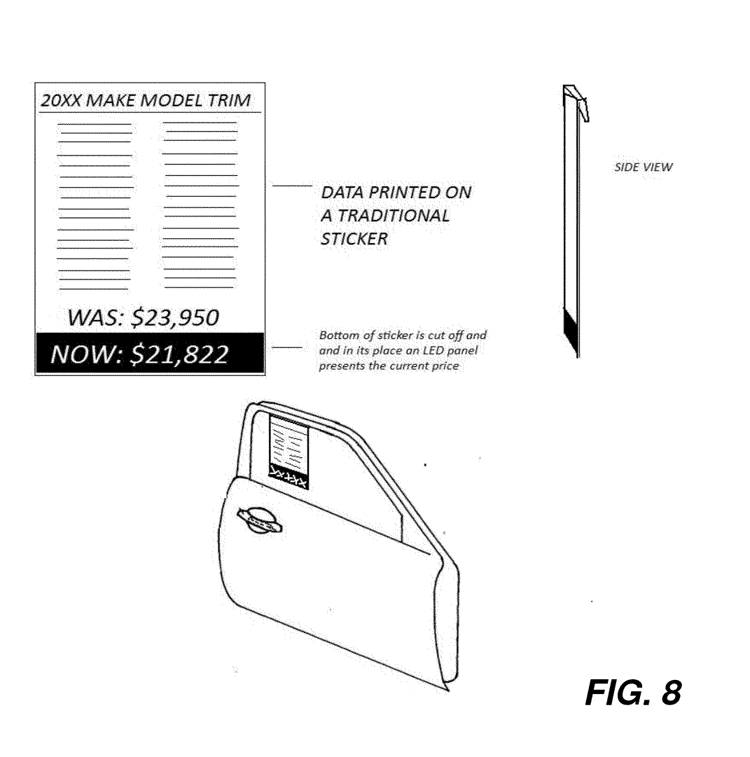

One particular way in which the present system and method may integrate the dynamic website into the business of selling vehicles is by encouraging viewing of the website at the physical location of the inventoried vehicle(s) (such as the dealer's lot). For example, in one embodiment, inventoried vehicles on the dealer's lot are outfitted with decals which may comprise a bar code, QR code, etc. which may be scanned using an application on a smart phone which causes the web browser of the smart phone to display the dynamic web page presenting the current, discounted price of the vehicle. In another exemplary embodiment, at least one inventoried vehicle (preferably each inventoried vehicle) is outfitted with a remote display which is perpetually showing the dynamic web page having the current pricing information for that vehicle. The remote display may be a low profile computer screen which has been affixed to each vehicle, but in other exemplary embodiments may be an electronic display of a different type. In another exemplary embodiment, at least one inventoried vehicle for which vehicle inventory data is stored in the at least one database 102 is physically adorned with a digital window sticker. The digital sticker may comprise a receiver and a LED screen which are in electronic communication with each other. The receiver electronically communicates with a wireless router that is in electronic communication with the at least one server 100. The at least one server 100 sends current, discounted price information for the vehicle to the wireless router which sends the data out as a signal. The receiver of the price sticker obtains the signals from the wireless router and communicates the current, discounted price of the vehicle to be displayed by the LED screen. FIG. 8 shows an exemplary embodiment of a window sticker comprising an LED screen that may be utilized in conjunction with a system and method of discounting and offering vehicles for sale.

In the exemplary embodiment shown in FIG. 4, the inventory of vehicles offered for sale is that belonging to a single car dealer however, it should be appreciated that in some preferred embodiments, the inventory of vehicles being offered for sale through the web page(s) generated by the system actually belongs to more than one dealer. In such an embodiment, the web page(s) may or may not indicate the specific dealer that maintains the vehicles in their inventory. In some embodiments where the system displays the inventory (or partial inventories) of more than one dealer, each participating dealer may have access to a total inventory web page as shown in FIG. 2 and/or a vehicle inventory data summary page as shown in FIG. 3, which permits qualified system users working for the dealer to manage the inventory of vehicle(s) that is displayed on the web page. For example, a sales manager for dealership A, may be able to log into a vehicle inventory summary data page which presents, and permits the manager to make modifications to information, sales prices, discount rates, etc. pertaining to, only vehicles that are inventoried by that dealership and that are being offered for sale on the web page(s) of the system. Meanwhile, a qualified sales manager from dealership B may be able to log into a vehicle summary data page which permits him or her to take action with respect to only vehicles that are inventoried by that dealership. In other exemplary embodiments where the inventories of more than one dealership are represented, a single individual—such as a manager that has contracted with more than one dealership—may be responsible for logging into a vehicle inventory summary data page which permits the manager to make modifications to information, sales prices, discount rates, etc. pertaining to more than one (in some cases all) of the dealerships that have vehicles being offered for sale through the web page(s). The vehicles being offered for sale preferably have their prices discounted by the system as has been discussed at great length above and it should be appreciated that all of the functions and features of the system that have been discussed could be utilized in conjunction with exemplary embodiments where vehicle(s) from more than one dealer are being offered for sale.

The following are examples of preferred embodiments of a system and method for discounting and promoting vehicles offered for sale:

### EXAMPLE 1

An exemplary embodiment for discounting and selling vehicles comprises at least one server 100 in electronic communication with at least one database 102. The at least one database comprises inventory data for at least one automobile being offered for sale wherein the inventory data comprises a discount rate for the vehicle as well as make, model, and mileage data for the vehicle. The discount rate is preferably in the form of an amount of money to be discounted off of the price of the vehicle per day. The at least one database 102 also comprises at least one data table which has been generated by the at least one server 100 wherein the at least one data table comprises pricing data for the at least one automobile which is reflective of the discount rate being applied to the price of the vehicle over a period of time. The data table preferably comprises at least 48 hours worth of price points for the automobile. Even when the discount rate is an amount of money to be discounted from the price of the automobile each day, there are preferably numerous discount intervals in each 24 hour period. For example, 30 minute discount intervals could be used. Referring to the exemplary tables of FIGS. 6 and 7, in such an exemplary embodiment, the price of the at least one automobile is discounted by a fraction of the discount rate every 30 minutes. The fraction of the discount taken from the price of the automobile every discount interval is preferably equal but different fraction amounts may also be used. The at least one server 100 generates a new data table comprising 48 hours worth of future pricing data every 24 hours. Preferably, each time a vehicle is added to the system (because, for example, a dealership has acquired a new vehicle), a discount rate is assigned to the vehicle. Accordingly, each vehicle being discounted by the system may have a discount rate which has been carefully selected and which is appropriate for the particular vehicle.

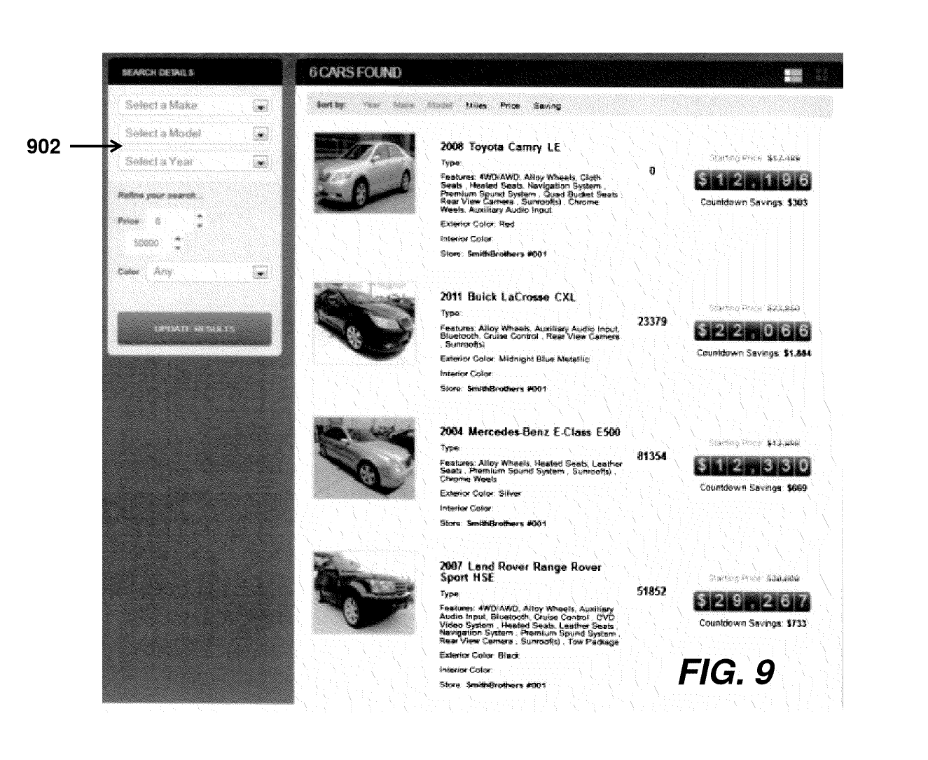

The at least one server 100 is in electronic communication with at least one remote computer. Preferably, the remote computer communicates with the at least one server over the internet. The at least one server may receive requests from the remote computer to view a web page comprising information pertaining to the at least one automobile being offered for sale. When the at least one server receives such a request, it may access the vehicle inventory data stored in the at least one database 102 to generate a dynamic web page that is sent for display by the remote computer. The web page preferably permits for a system user to input search criteria relating to vehicles and to send the search criteria to the at least one server. FIG. 9 shows an exemplary embodiment of a web page which may be generated by the at least one server which permits for a system user to select/enter search criteria 902 and cause it to be sent to the at least one server 100. As can be seen in FIG. 9, search criteria may comprise Make 904, Model 906, Year 908, Price 910, and/or Color 912. When a system user sends at least one search criteria to the at least one server 100, the server may obtain vehicle inventory data from the at least one database 102 and utilize the obtained search criteria to generate search results comprising at least one automobile being offered for sale which satisfies the search criteria. For example, if the at least one server 100 receives a request from a remote computer to view all of the red cars being offered for sale by a dealership and the car dealership has fifty cars being offered for sale—all of which have their vehicle inventory data (which in this example would include color) stored in the at least one database and eight of which are red—the at least one server would access the stored vehicle inventory data and generate a search results web page including information pertaining to each of the eight red cars and send the search results web page to the remote computer for viewing.

Once the at least one server has generated and sent search results for viewing at the remote computer, a system user may be able to select one or more of the vehicles represented within the search results and indicate to the at least one server that it is interested in viewing more information pertaining to the vehicle(s). Such an indication may be made by selecting one of the vehicles with a pointing device such as a mouse. When the at least one server 100 receives an indication from a remote computer to view more details pertaining to at least one automobile being offered for sale, the at least one server may obtain vehicle inventory data pertaining to the selected vehicle(s) from the at least one database and generate a web page for the selected vehicle(s) utilizing at least some of the vehicle inventory data. An example embodiment of such a web page is illustrated in FIG. 9. While the web page does not have to include all of the vehicle inventory data for the vehicle, the web page preferably includes the information pertaining to the vehicle that would be important to potential buyers. FIG. 4 shows an exemplary embodiment of a web page that could be generated by the at least one server which presents additional information pertaining to a vehicle being offered for sale. As can be seen in FIG. 4, the at least one system preferably generates a web page which displays the starting sale price 406 for the vehicle and a current, discounted price 408 for the vehicle. The current, discounted price for the vehicle may be obtained by the at least one server by accessing at least one data table which comprises pricing data for the selected vehicle. Preferably, the server has access to a timekeeping device which it references when it receives a request from a remote computer to view information pertaining to at least one vehicle being offered for sale and it is the time provided by the timekeeping device which determines which pricing value from the data table is to be utilized by the at least one server 100 in generating a web page which comprises additional information pertaining to a vehicle being offered for sale. While the at least one server sends for display the starting price of the at least one vehicle and a discounted price, the at least one server preferably does not indicate how long the discount rate has been applied to the automobile or how frequently the vehicle's price has been discounted. This is designed to encourage system users to spend more time on the dynamic website so that they can calculate the discount rate and attempt to predict a future price of the vehicle.

A web page which presents additional information pertaining to at least one vehicle being offered for sale may permit for system users to send notification requests to the at least one server wherein the notification request indicates a sales price at which the system user would consider purchasing the vehicle. FIG. 4 at 410 illustrates an exemplary web page which permits system users to send a request for notification to the at least one server 100.

Though the at least one server discounts the price of at least one vehicle being offered for sale, presents information pertaining to the at least one vehicle being offered for sale, and processes notification requests pertaining to the at least one vehicle utilizing logic in order to engage potential buyers, the at least one server does not complete a sales transaction in preferred exemplary embodiments. In other words, the actual sale of the at least one automobile is still completed using, for example, a salesman at a car dealership. This may permit a dealership to offer additional features to the buyer, assist with financing options, etc. Once the sale has been completed, the salesperson—or another individual acting on behalf of the dealership who has appropriate access to the system—may send a notification to the at least one server that the vehicle has been sold. Once such a notification is obtained by the at least one server, the server will no longer send information pertaining to the vehicle to be displayed by a remote computer upon receiving a request from the computer to view information pertaining to at least one vehicle being offered for sale.

### EXAMPLE 2

An exemplary embodiment for discounting and selling vehicles comprises at least one server 100 in electronic communication with at least one database 102. The at least one database 102 comprises inventory data for at least one vehicle being offered for sale wherein the inventory data comprises a discount rate for the vehicle as well as make, model, and mileage data for the vehicle. The discount rate is preferably an amount of money to be discounted off the price of the vehicle by the at least one system server each day. At least some of the vehicle inventory data within the at least one database 102 may have been obtained by the system by periodically obtaining data files which comprise inventory data for vehicles newly acquired by the dealership. V-AUTO® is an example of a source for such data files. Even though some of the inventory data for at least one vehicle being offered for sale has been obtained by the at least one server by periodically obtaining data files, some inventory data pertaining to the at least one automobile may have been obtained by the at least one server from a system user accessing an interface with a remote computer that is in electronic communication with the at least one server. FIG. 3 shows an exemplary embodiment of an interface which may be generated by the at least one server and sent for display be a remote computer wherein the interface permits a system user to send inventory data pertaining to at least one vehicle being offered for sale to the at least one database. Accessing the interface requires a system user to send proper identification to the at least one server (for example a username and password). In a preferred embodiment, the discount rate for at least one automobile being offered for sale has been supplied to the at least one server by having been entered in a data field of on interface such as the one shown in FIG. 3 and sent to the at least one server.

Once a system user has entered at least a discount rate at the interface, the system user may be able to send an instruction to the at least one server to begin discounting the sales price of the at least one vehicle in accordance with the supplied discount rate. For example, the interface may include a “status” indicator 312 which may be modified by a system user. In the exemplary interface of FIG. 3, the status indicator may be set to a “live status” (by using a pointing device such as a mouse or keyboard) which sends an instruction to the at least one server to begin applying the discount rate to the price of the at least one automobile. When this occurs, the at least one server may generate a table of pricing data pertaining to the vehicle wherein the table of data comprises discounted price points for the vehicle at least up through the time at which the at least one server is scheduled to generate such a table for each vehicle being offered for sale. So, for example, if the at least one server generates the pricing table(s) each night at midnight but a system user has placed a newly acquired vehicle in “live status” at 2 PM, the at least one server may generate a table of data for the newly acquired vehicle wherein the table comprising ten hours worth of future, discounted price point data. The number of price points in the table would be dependent on the discount interval being utilized, which in some exemplary embodiments may also be supplied to the at least one server via the interface where the discount rate is entered. At midnight, the at least one server may generate at least one data table comprising future discounted price points for the newly acquired vehicle as well as for all of the other live vehicles being offered for sale (in some embodiments the at least one server generates a separate data table for each vehicle).

The at least one server may receive requests from a remote computer to view each vehicle being offered for sale which has been set to a certain status by a system user with appropriate access. FIG. 2 shows an example of a web page 200 which permits for a system user with appropriate access to view all vehicles being offered for sales which have been set to a certain status. As shown in FIG. 2, the at least one server may designate each vehicle being offered for sale under at least one of the following status 202: New, Processing, Live, Pause, All, and Safety Net. In this embodiment, the “new” status indicates vehicles for which inventory data has just been obtained by the at least one server (because, for example, the vehicle was recently acquired by the dealership) and which data has not yet been reviewed and/or supplemented by a system user. The “processing” status may indicate vehicles which are being prepared for being offered for sale by the dealership. “Live” status means that the vehicle has been processed, has been assigned a discount rate by a system user with appropriate access, and that the system is applying the discount rate to the price of the vehicle. “Pause” status means that the system's application of the discount rate to the price of a vehicle has been at least temporarily deactivated—for example, because a vehicle was on an overnight test drive. A “live” vehicle may be set to “pause” status and vice versa by a system user accessing an interface such as that shown in FIG. 2 and/or an interface such as that shown in FIG. 3. Selecting the “All” status instructs the at least one server that you wish to see all vehicles for which inventoried data exists in the at least one database. The “Safety Net” status is for vehicles which have been discounted by the system to the safety net price and thus are no longer being discounted by the system. The interfaces generated by the at least one system server which require appropriate log-in credentials may permit for management personnel of a car dealership to manage the discounting and promotion of its inventoried vehicles by the system. In other exemplary embodiments, the interfaces are not accessed by employees of the entity selling the vehicles but by the employees of a third party which is managing the inventory for the dealership.

Any embodiment of the disclosed system and method may include any of the optional or preferred features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to affect the described invention. Many of those variations and modifications will provide the same result and fall within the spirit of the claimed invention. It is the intention, therefore, to limit the invention only as indicated by the scope of the claims.

What is claimed is:

1. A computerized system for promoting the sale of vehicles comprising:
a computer server;
a database in communication with the computer server;
software instructions that, when executed by the computer server, cause the computer server to perform steps comprising:
receiving a starting sale price of at least one vehicle;
receiving a discount rate for the at the vehicle;
receiving a discount interval for the vehicle;
calculating a plurality of future sale prices for the vehicle;
receiving a request from a remote computer to provide a sale price for the vehicle; and
transmitting to the remote computer, a calculated sale price that corresponds to a time that the request to provide a sales price is received.

2. The computerized system of claim 1, where the received starting sale price is received from a computer database.

3. The computerized system of claim 1, where the received starting sale prices is entered by an authorized user.

4. The computerized system of claim 1, where calculating a plurality of future sale prices comprises the sub-steps of:
calculating a discount amount using the discount rate; and
calculating each future sale price by subtracting the discount amount from a previous sale price until a preselected minimum sale price is reached.

5. The computerized system of claim 4, where future sale prices are calculated for a predetermined period of time and stored in the database.

6. The computerized system of claim 1, further comprising software instructions that, when executed by the computer server, cause the computer server to perform steps comprising:
receiving from a remote computer, a request for notification when the calculated sale price for a vehicle reaches a certain amount; and
transmitting a notification to the remote computer when the calculated sale price reaches the certain amount.

7. The computerized system of claim 6, further comprising software instructions that, when executed by the computer server, cause the computer server to transmit a notification to an authorized user comprised of the received request for notification.

8. The computerized system of claim 7, where the transmitted notification to the authorized user does not occur until the time at which the calculated sale price is within a predetermined amount from the certain amount.

9. A computerized system for promoting the sale of a vehicle comprising:
a computer server;
a database in communication with the computer server;
an electronic display device located in close proximity to a vehicle and in communication with the computer server;
software instructions that when executed by the computer server cause the computer server to perform steps comprising:
receiving a starting sale price of at least one vehicle;
receiving a discount rate for the at the vehicle;
receiving a discount interval for the vehicle;
calculating a plurality of future sale prices for the vehicle;
transmitting to the electronic display device, at one or more preset times,
the calculated future sale price that corresponds to a then current time.

10. The computerized system of claim 9, where the received starting sale price is received from a computer database.

11. The computerized system of claim 9, where the received starting sale prices is entered by an authorized user.

12. The computerized system of claim 9, where calculating a plurality of future sale prices comprises the sub-steps of:
calculating a discount amount using the discount rate; and
calculating each future sale price by subtracting the discount amount from a previous sale price until a preselected minimum sale price is reached.

13. The computerized system of claim 12, where the minimum sale price is calculated based upon a cost of the vehicle.

14. The computerized system of claim 12, where the plurality of future sale prices are stored in the database.

15. A computerized method for promoting the sale of a vehicle comprising the steps of:
receiving at a computer server, at least one unique vehicle identifier;
receiving at a computer server, a discount rate;
determining a discount time period;
calculating a plurality of discounted prices for a vehicle corresponding to the unique vehicle identifier, where each of the plurality of discounted prices corresponds to a series of discount time periods beginning at a predetermined starting time; and
transmitting to a display viewable by a potential purchaser, at least one discounted price, where such transmission takes place at a time at least as late as the predetermined starting time combined with a sum of discount time periods corresponding to discounted price transmitted.

16. The computerized method of claim 15, where the display viewable by a potential purchaser is located remotely from the computer server.

17. The computerized method of claim 16, where the step of transmitting to a display occurs, at least in part, over a wireless computer network.

18. The computerized method of claim 15, comprising the additional steps of:
receiving from a remote computer, a request for notification when the calculated discounted price for a vehicle reaches a certain amount; and
transmitting a notification to the remote computer when the calculated discounted price reaches the certain amount.

19. The computerized method of claim 16, further comprising the step of transmitting a notification to an authorized user when the calculated discounted price reaches a price within a predetermined range of the certain amount.
